(19) United States
(12) Patent Application Publication
(10) Pub. No.: US 2025/0212241 A1
(43) Pub. Date: Jun. 26, 2025

(54) MULTI-ACCESS POINT COORDINATION OPTIMIZATION USING RESOURCE UNIT-SPECIFIC REPORTING

(71) Applicant: Cisco Technology, Inc., San Jose, CA (US)

(72) Inventors: Malcolm M. SMITH, Richardson, TX (US); Indermeet S. GANDHI, San Jose, CA (US)

(21) Appl. No.: 18/627,041

(22) Filed: Apr. 4, 2024

Related U.S. Application Data
(60) Provisional application No. 63/613,693, filed on Dec. 21, 2023.

(51) Int. Cl. H04W 72/54; H04B 17/318; H04B 17/336; H04W 72/0453

(52) U.S. Cl. CPC H04W 72/54; H04B 17/328; H04B 17/336; H04W 72/0453

(57) ABSTRACT

Techniques for optimizing spatial reuse in wireless networks are provided. A first network device receives an instruction from a second network device regarding reporting a radio frequency environment of the first network device. The first network device measures one or more performance metrics on each respective sub-channel of a plurality of sub-channels within the radio frequency environment. The first network device sends a report to the second network device, comprising the one or more performance metrics. The first network device receives an allocation for one or more sub-channels, of the plurality of sub-channels, from the second network device. The first network device uses the allocated one or more sub-channels for data exchange.

### CROSS-REFERENCE TO RELATED APPLICATIONS

This application claims benefit of co-pending U.S. provisional patent application Ser. No. 63/613,693 filed Dec. 21, 2023. The aforementioned related patent application is herein incorporated by reference in its entirety.

### TECHNICAL FIELD

Embodiments presented in this disclosure generally relate to wireless communication. More specifically, embodiments disclosed herein relate to methods of optimizing multi-AP coordination (MAPC) spatial reuse (SR) through RU-specific overlapping basic service set (OBSS) reporting and dynamic allocation.

### BACKGROUND

In high-density Wi-Fi 8 networks, spatial reuse (SR) techniques are implemented to enable concurrent transmissions between multiple devices. Spatial reuse can be achieved by optimizing the transmit power levels of devices and managing how they access the network medium between Overlapping Basic Service Sets (OBSSs). This approach improves the overall network throughput. However, legacy standards like IEEE 802.11 only provide OBSS information at a broad Basic Service Set (BSS) or access point (AP) level through beacon reports. This per-BSS level reporting is insufficient for fully capitalizing on spatial reuse opportunities because it overlooks the varying channel conditions and potential interferences within different segments of the overlapping zones.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network environment that supports RU-specific overlapping basic service set (OBSS) reporting and dynamic allocation, according to some embodiments of the present disclosure.

FIG. 2 depicts an example 20 MHz channel that includes resource units (RUs) of different widths, according to some embodiments of the present disclosure.

FIG. 3 depicts an example process of allocating RUs for spatial reuse based on RU-specific reporting, according to some embodiments of the present disclosure.

FIG. 4 depicts an example method of an AP optimizing RU allocation for spatial reuse, utilizing detailed per-RU reporting from associated client devices, according to some embodiments of the present disclosure.

FIG. 5 depicts an example method of a client device scanning its radio frequency environment and reporting per-RU performance metrics for optimized RU allocation, according to some embodiments of the present disclosure.

FIG. 6 is a flow diagram depicting an example method for RU allocation guided by detailed per-sub-channel reporting and analysis, according to some embodiments of the present disclosure.

FIG. 7 depicts an example client device supporting RU-specific reporting, according to some embodiments of the present disclosure.

FIG. 8 depicts an example AP supporting dynamic RU allocation based on RU-specific reporting, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a first network device, an instruction from a second network device regarding reporting a radio frequency environment of the first network device, measuring, by the first network device, one or more performance metrics on each respective sub-channel of a plurality of sub-channels within the radio frequency environment, sending, by the first network device, a report to the second network device, comprising the one or more performance metrics, receiving, by the first network device, an allocation for one or more sub-channels, of the plurality of sub-channels, from the second network device, and using, by the first network device, the allocated one or more sub-channels for data exchange.

Other embodiments in this disclosure provide one or more non-transitory computer-readable media containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### EXAMPLE EMBODIMENTS

The present disclosure provides techniques for optimizing RU allocation for spatial reuse in a multi-AP environment based on RU-specific OBSS reporting and analysis.

In high-density networks (e.g., Wi-Fi 8 networks), spatial reuse techniques facilitate concurrent transmissions by fine-tuning transmit power levels of devices and managing medium access between overlapping BSSs (OBSSs). This strategy improves the overall network throughput. However, legacy standards like IEEE 802.11 only provide OBSS information at a broad per-BSS or per-AP level through beacon reports.

The evolution of Wi-Fi standards, specifically with the introduction of 802.11be, brings advancements like Orthogonal Frequency-Division Multiple Access (OFDMA) and punctured channels. With these developments, OBSS interference and channel conditions can vary significantly across different frequency resource units (RUs) or 20 MHz sub-channels. The complexity increases with standards like 802.11bn/UHR, which introduces methods like Continuous Orthogonal Frequency-Division Multiple Access (C-OFDMA) or Continuous Frequency-Division Multiple Access (C-FDMA) whereby the multi-AP coordinator may desire to consider co-channel-interference (CCI) more precisely, on a per-RU or per-sub-channel basis. Given these advancements, the broad per-BSS or per-AP level reporting is insufficient to capitalize on the frequency-selective spatial reuse opportunities.

Embodiments of the present disclosure introduce mechanisms or systems that enable the client devices (or stations (STAs)) to report OBSS channel condition at a per-RU level to their associated APs. The per-RU level reporting allows the APs to properly allocate RUs, or adaptively tune transmit powers and/or medium access parameters on a per-RU basis (e.g., selecting MAPC modes like C-OFDMA or C-FDMA, or adjusting OBSS-packet detect (PD) thresholds), therefore optimizing the wireless networks for maximal spatial reuse gains.

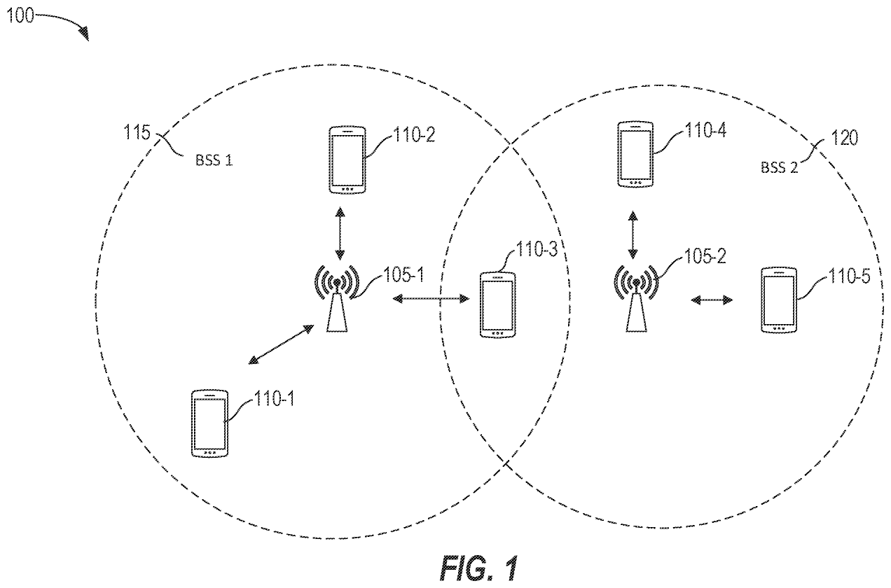

FIG. 1 depicts an example wireless network environment 100 that supports RU-specific overlapping basic service set (OBSS) reporting and dynamic allocation, according to some embodiments of the present disclosure.

In the illustrated example environment, two basic service sets (BSSs) are depicted. BSS 1 (115) includes AP 105-1 and its associated STAs 110-1, 110-2 and 110-3. BSS 2 (120) includes AP 105-2 and its associated STAs 110-4 and 110-5. STA 110-3 is located within the overlapping coverage area of both BSS 1 and BSS 2.

Although STA 110-3 is associated with AP 105-1, its physical location near another BSS (such as BSS 2) offer it the chance to engage in spatial reuse. For example, STA 110-3 may reuse a sub-channel (or an RU) that is not currently being utilized to its full capacity by STAs 110-4 or 110-5 in BSS 2.

In some embodiments, to identify sub-channels (or RUs) being utilized by devices from a neighboring BSS, such as STAs 110-4 or 110-5, STA 110-3 may monitor frames transmitted between AP 105-2 and STAs 110-4 or 110-5. These frames may include BSS Color information in the PHY headers, which indicates if the detected frames are from the STA 110-3's own BSS (or a BSS sharing the same color as BSS 1) or from the neighboring BSSs (or BSSs having a different color from BSS 1). In some embodiments, the MAC headers of these frames may contain source and destination MAC addresses, which provide additional context for identifying traffic within BSS 2. In embodiments where uplink OFDMA is used, STA 110-3 may learn RU allocations for multiple STAs by listening to trigger frames sent by AP 105-2.

In some embodiments, upon detecting sub-channels (or RUs) utilized by STAs 110-4 or 110-5, STA 110-3 may measure the signal strength and/or transmit power level of these sub-channels (or RUs), and compare it to the OBSS/PD threshold. If the signal strength on a sub-channel (or RU) falls below the threshold, the STA 110-3 may infer that the sub-channel (or RU) is not fully utilized. STA 110-3 may then report these per-RU observations to its associated AP 105-1, which can, in turn, make informed decisions to permit STA 110-3 to use these identified RUs for data transmission. In some embodiments, relying on the per-RU reporting, AP 105-1 may further refine its network settings or instruct STA 110-3 to make specific adjustments to maximize (or at least improve) spatial reuse gains. For example, in embodiments where advanced MAPC modes like C-OFDMA or C-FDMA are available, AP 105-1 may switch its MAPC mode based on per-RU reporting results. In embodiments where the wireless medium is busy with a lot of wireless traffic, AP 105-1 may instruct STA 110-3 to adjust its transmit power to ensure both robust communication on the selected RU while avoiding (or mitigating) co-channel interference. In embodiments where the wireless environment is busy and RUs are in high demand, AP 105-1 may decrease the OBSS/PD threshold to enforce a more conservative frequency reuse strategy. By setting a lower OBSS/PD threshold, STA 110-3 becomes more sensitive to the signals from other BSSs. As a result, STA 110-3 may perceive fewer RUs as available for spatial reuse because it is only allowed to use RUs whose signal strength falls below the threshold. In embodiments where the wireless environment is less congested, the AP 105-1 may implement a more aggressive reuse strategy by increasing the OBSS/PD threshold, to make more RUs available for reuse. However, the increase in OBSS/PD threshold should be carefully balanced to avoid co-channel interference that can degrade the communication quality for both overlapping networks.

APs 105 may correspond to a variety of network devices, such as wireless routers, network switches, mesh network nodes, or other devices that provide connectivity and support for various network services, including but not limited to distributing IP addresses, providing wireless access for devices, managing network traffic, and facilitating secure data transmission. STAs 110 may be stationary or mobile, and may be referred to as user devices (UEs), client devices, mobile devices, and terminals or access terminals, among others. STAs 110 may represent any devices capable of connecting to a wireless network to access services and communicate with other devices within (and/or or outside of) the network. STAs 110 may include a wide range of device types, including, but not limited to, smartphones, tablets, laptops, smart sensors, and other Internet of Things (IoT) devices.

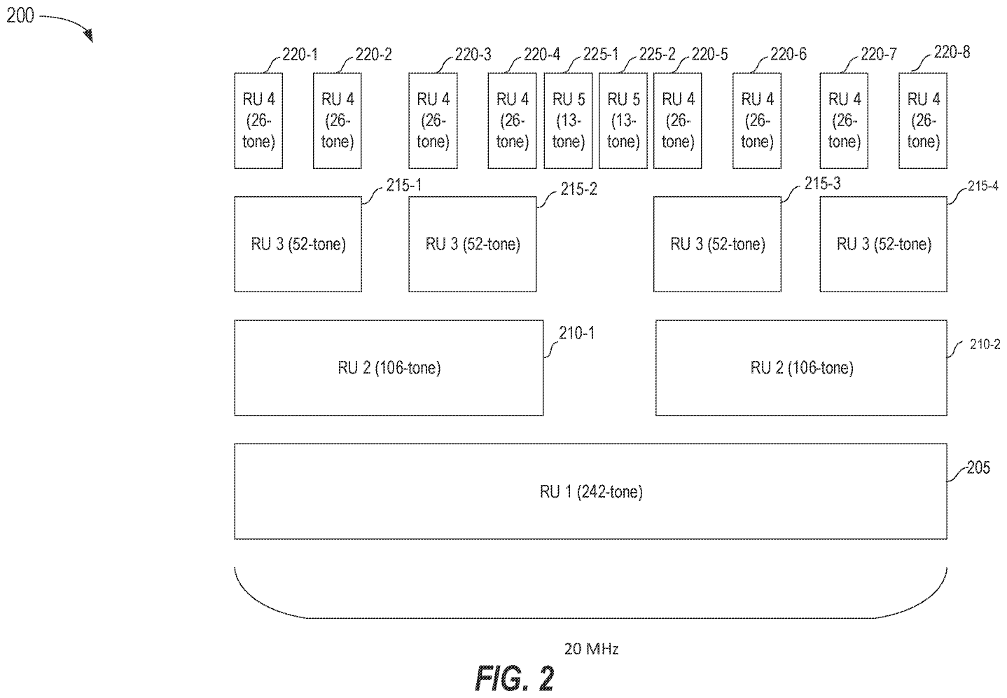

FIG. 2 depicts an example 20 MHz channel 200 that includes resource units (RUs) of different widths, according to some embodiments of the present disclosure.

As illustrated, the 20 MHz channel may be divided into various RUs of different widths, with each RU allocated to a client device for concurrent data transfer. For example, the channel may include one RU 205 comprising 242 tones, designed to serve a single client device (e.g., STA 110-1 of FIG. 1) for high data rate transmissions. In some embodiments, the channel may be divided into two RUs 210, each consisting of 106 tones. The two RUs 210 may be allocated to two client devices (e.g., STAs 110-1 and 110-2 of FIG. 1) for transmitting data concurrently. In some embodiments, the channel may be segmented into four RUs 215, each with 52 tones. The four RUs 215 may be allocated to up to four client devices for concurrent data transmission. In some embodiments, the channel may be segmented into eight RUs 220 with 26 tones and two RUs 225 with 13 tones, and accommodate up to ten client devices for simultaneous transmission.

Within the 20 MHz channel, RUs may be allocated to different STAs by their respective APs within their own BSSs. In some embodiments, before allocating RUs, an AP may first instruct the STAs (e.g., STA 110-3 of FIG. 1) to perform a radio frequency environment scan. The scan is intended to detect RUs that are either unused (where signal strength is below the noise floor threshold), or utilized by devices in other BSSs (e.g., BSS 2 of FIG. 1). For example, when STA 110-3 requests resources for data transmission, it may first be instructed to perform a RF scan, and find that RU 215-1 and RU 215-2 are used by its BSS (e.g., by STA 110-1 or 110-2 of FIG. 1), RU 215-3 is unoccupied, and RU 215-4 is in use by a device from BSS 2 (e.g., STA 110-4 or 110-5 of FIG. 1) with signal strength falling below a defined OBSS/PD threshold. STA 110-3 may then report the per-RU monitoring results to its associated AP 105-1, which can conclude that RU 215-3 (unoccupied) and RU 215-4 (underutilized by neighboring BSSs) are viable for allocation to STA 110-3. In some embodiments, AP may prioritize empty RUs, like RU 215-3, over those with detectable but manageable interference from other BSSs, like RU 215-4. In some embodiments, such as when the AP (e.g., AP 105-1 of FIG. 1) is part of a coordination group (CG) and acts as a follower, the AP may forward this per-RU reporting and its allocation decision to the leader AP (e.g., AP 105-2 of FIG. 1) for further coordination and/or approval. In some embodiments, such as when the AP (e.g., AP 105-1 of FIG. 1) is part of a CG and acts as a leader, the AP may integrate per-RU reports from all follower APs (e.g., AP 105-2 of FIG. 1), and evaluate the broader network conditions to make informed decisions on RU allocation across OBSSs.

Although the depicted segmentation of the example channel is provided for conceptual clarity, in some embodiments, the division of the channel may vary to accommodate any number of RUs with different widths to optimize network efficiency. For example, in some embodiments, the channel may be divided into three RUs, including one RU (e.g., 210-1) with 106 tones and two RUs (e.g., 215-1) with 52 tones, allowing it to serve up to three client devices simultaneously. In some embodiments, the channel may be divided into four RUs, one RU (e.g., 215-1) with 52 tones, and two RUs with 26 tones each (e.g., 220-1).

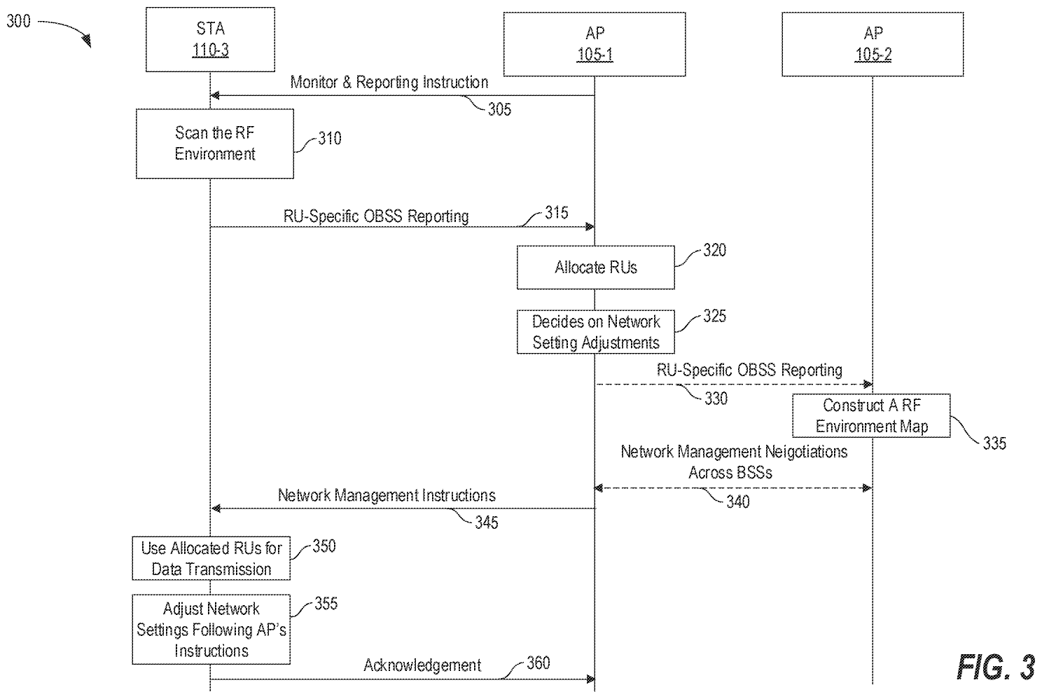

FIG. 3 depicts an example process 300 of allocating RUs for spatial reuse based on RU-specific reporting, according to some embodiments of the present disclosure.

In the illustrated example process, AP 105-1 (which may correspond to AP 105-1 as depicted in FIG. 1) instructs one of its associated STA 110-3 (which may correspond to STA 110-3 as depicted in FIG. 1) to scan its RF environment (step 305). The instruction is sent for collecting data on the current state of spectrum usage within and around BSS 1 (as depicted in FIG. 1).

In some embodiments, the instruction may include guidelines regarding the AP 105-1's general reporting policy, which may detail the granularity of the signal strength measurements. For example, the guidelines may specify reporting signal strength (e.g., received signal strength indicator (RSSI), signal-to-noise (SNR)) for each RU (or sub-channel), or for a defined number of RUs (or sub-channels). In the absence of explicit granularity instructions, STA 110-3 may assume that a per-RU (or per-sub-channel) reporting format will be followed. In some embodiments, the general policy provided by AP 105-1 may further indicate the type of reporting by the STA 110-3, such as periodic reporting, on-demand reporting, or threshold-driven reporting. As used herein, the periodic reporting may be initiated by the STA 110-3, and enable AP 105-1 to have regular updates on the RF environments, and facilitate dynamic RU allocation based on the spectrum's current usage status. The on-demand reporting may be initiated by the AP 105-1, such as when there is a need to make immediate decisions regarding RU allocations (e.g., receiving requests from their associated STAs for data transmission), or to assess the network's performance. The threshold-driven reporting may be triggered by specific conditions, such as a certain level of signal strength drop (e.g., a 3 dB decrease). The threshold-driven reporting ensures that the AP 105-1 is alerted to significant changes in the STA 110-3's RF environment that could impact its network performance or the quality of service.

In some embodiments, the instruction from AP 105-1 may target a specific STA, such as a device located at the cell edge or within an overlapping area between BSSs (e.g., STA 105-3 of FIG. 1), for detailed RU signal strength (e.g., RSSI, SNR) measurement. Although the example environment 100 as depicted in FIG. 1 only shows two BSSs (e.g., BSS 1 and BSS 2), there may be several additional BSSs (not shown) in the environment. AP 105-1 may identify BSS 2 as a potential source of interference due to its proximity to STA 110-3. Based on the identification, AP 105-2 may provide the identifier (e.g., BSSID or BSS Color) associated with BSS 2 to STA 110-3. With the provided identifier, STA 110-3 may accurately identify which RUs are being utilized by devices in BSS 2, and/or assess their respective signal strengths. Relying on the specific monitoring of RUs occupied by BSS 2, AP 105-1 may make informed decisions regarding RU allocations and adjust its network settings, such as switching to C-OFDMA or C-FDMA mode, adjusting transmit power levels or medium access parameters. The more specific and targeted monitoring and reporting may help STA 110-3 to maximize (or at least improve) spatial reuse gains while avoiding (or at least mitigating) co-channel interference.

After receiving the monitoring and reporting instructions from AP 105-1, STA 110-3 initiates a spectrum scan to collect RU-specific data regarding spectrum usage (step 310). The process may include the STA identifying whether an RU is occupied and, if so, determining whether the RU is used by devices within its own BSS or by devices from neighboring BSSs. In some embodiments, the identification of RU occupancy may be achieved through passive scanning methods, such as listening to beacon reports or trigger frames, or by examining the BSSIDs or BSS Colors included in the headers of frames transmitted between neighboring APs and their associated STAs. In some embodiments, the scanning may be general, configured to identify the sources for all RUs in the channel being used. In some embodiments, the scanning may be more specific, focusing on the BSSIDs or BSS Colors provided by the AP 105-1. The BSSID-specific or BSS Color-specific scanning may enable STA 110-3 to identify RUs that are utilized by a particular BSS (e.g., BSS 2 of FIG. 1). In some embodiments, the identification of RU occupancy may involve active probing techniques, which may include actively sending requests to devices within the spectrum for channel occupancy information.

Given STA 110-3's position is at the cell edge or within an area of overlapping BSSs, it has the potential to perform spatial reuse. In these zones of overlap, RUs that are not fully utilized by neighboring BSSs may be candidates for STA 110-3 to reuse, which enhances the STA 110-3's network efficiency without substantially increasing interference. Following the identification of RUs occupied by devices from neighboring BSSs, STA 110-3 may evaluate their level of utilization (e.g., determining whether those RUs are being utilized to their full capacities). In some embodiments, the evaluation may involve measuring the signal strength (e.g., RSSI, SNR) of transmissions on those RUs and comparing it with the OBSS/PD threshold set by AP 105-1. If the signal strength on an RU falls below the threshold, the RU is considered not fully utilized, presenting a potential opportunity for spatial reuse by STA 110-3. If the signal strength on an RU meets or is above the threshold, the RU is considered as busy or occupied, and STA 110-3 should avoid using it to minimize co-channel interference.

Upon completing the spectrum scan, STA 110-3 may aggregate the RU-specific monitoring data into a report, and send it to AP 105-1 (step 315). The report may detail the occupancies of the RUs within the scanned spectrum and include respective performance metrics, such as signal strength, or transmit power levels, for each identified RU. For example, the report may distinguish between RUs that are unoccupied, those utilized by devices within STA 110-1's own BSS (or BSSs sharing the same color), and RUs occupied by devices from neighboring BSSs (or BSSs having different colors), as identified by their BSSIDs or BSS Colors. For each RU, the report may provide measured signal strength or power levels, which offer AP 105-1 a detailed view of the current spectrum usage and potential interference levels.

In some embodiments, a new OBSS Spatial Reuse Report element may be defined specifically for uplink reporting by STAs to APs. The report element may include multiple sections, each designed to provide different insights into the spatial reuse opportunities and potential interference within the network. These sections may include, but are not limited to, the OBSS Identity Information section, the RU Power Level Report section, and the RU RSSI/SNR Report section. In some embodiments, the OBSS Identity Information section may contain identifiers such as BSSID, SSID, or BSS Color, which can be used to distinguish the sources of signals detected by the STA (e.g., devices within the STA's own BSS or from neighboring BSSs). In some embodiments, the RU Power Level Report section may include the power levels measured by the STA (e.g., STA 110-3) for each RU, which help the AP (e.g., AP 105-1) in assessing the current usage intensity of the spectrum. Based on the detected power levels, AP may identify RUs that are either lightly used or not used, and reallocate these RUs for spatial reuse without causing undue co-channel interference. In some embodiments, the RU RSSI and/or SNR Report section may include RSSI and/or SNR values measured for each RU. The signal strength values may enable AP to evaluate the signal quality and the level of interference within each RU. An OBSS/PD threshold may be defined to determine the suitability of RUs for spatial reuse based on SNR or RSSI values. SNR and/or SSI values that meet or exceed the threshold may suggest that the RUs are potentially congested, and reuse of these RUs may cause significant co-channel interference. RUs with SNR and/or RSSI values falling below the threshold may be considered underutilized, presenting opportunities for spatial reuse.

In some embodiments, the OBSS Spatial Reuse Report element may be incorporated into existing network communication frames, such as Beacon Report Request frames or Beacon Report Response frames. The integration may facilitate efficient communication of RU-specific spatial reuse data within the network's standard operational flows. In embodiments where AP specifically requests RU-level reports concerning specified OBSSs (like BSS 2 as depicted in FIG. 1), the OBSS Spatial Reuse Report element may be included in a Beacon Report Request frame. The detailed RU-level reports for the specified OBSSs may then be delivered back to the AP, in the Beacon Report Response frames. In embodiments where the AP broadcasts its general reporting and monitoring policy (e.g., detailing the desired granularity of data collection or frequency of reporting) without specifying particular OBSSs of interest, STA may aggregate the general, broad RU-level reports within the Beacon Report Response frames, and transmit them to the AP.

Based on the RU-specific OBSS reporting from STA 110-3, AP 105-1 proceeds to allocate RUs for STA 110-3's data transmission (step 320). In some embodiments, AP 105-1 may construct a detailed map of its RF environment utilizing the RU-specific data. The map may include various characteristics of each RU within the channel, such as occupancy status (whether occupied by its own BSS or by devices from neighboring BSSs), signal strength, and power levels. Using the detailed FR environment map, AP 105-1 may then implement spatial reuse scheduling algorithms to optimize channel allocation and maximize (or at least improve) spatial reuse gains. For example, the AP 105-1 may analyze the collected data to identify RUs that are underutilized by neighboring BSSs or are currently unused (e.g., indicated by their RSSI falling between the defined noise floor threshold). AP 105-1 may relocate these RUs to STA 110-3 to enhance network capacity and throughput without significantly increasing interference. In some embodiments, the AP 105-1 may give priority to unused RUs over underutilized RUs, as they present a lower risk of causing interference.

In some embodiments, the determination of whether RUs are not fully utilized by neighboring BSSs may involve comparing the detected signal strength against the predetermined OBSS/PD threshold. If an RU's signal strength from the neighboring BSS falls below the threshold, it suggests that the RU is not being used to its full capacity, and can be reallocated to STA 110-3 for spatial reuse without causing undue co-channel interference.

In addition to RU allocation, in some embodiments, AP 105-1 may take additional steps to adjust network settings or medium access parameters to further maximize (or at least improve) spatial reuse gains (step 325). In embodiments where advanced MAPC modes like C-OFDMA or C-FDMA are available, AP 105-1 may decide whether to switch to these modes based on the per-RU monitoring data. These MAPC modes offer more granular control over the spectrum, to enable more efficient spatial reuse, especially in high-density environments. In some embodiments, AP 105-1 may instruct STA 110-3 to modify (e.g., to slightly increase) its transmit power. The adjustment may be implemented to ensure robust communication between AP 105-1 and STA 110-3 while avoiding (or at least mitigating) co-channel interference with nearby devices. In some embodiments, frequency reuse patterns may be dynamically adjusted in response to real-time network conditions. For example, in densely populated areas with high interference levels, AP 105-1 may enforce more conservative frequency reuse to minimize co-channel interference. This may include lowering the OBSS/PD threshold, making STA 110-3 more sensitive to signals from other BSSs, preventing potential interference. In a less congested network, the AP 105-1 may adopt a more aggressive reuse strategy by increasing the OBSS/PD threshold. The adjustment would render STA 110-3 less sensitive to signals from other BSSs and, therefore make more RUs viable for spatial reuse. However, any adjustments to the OBSS/PD threshold may be made with caution to prevent co-channel interference that could compromise the quality of service across all involved BSSs. Carefully balancing the threshold may help to optimize network performance while ensuring efficient use of the shared spectrum.

In embodiments where AP 105-1 and AP 105-2 (which may correspond to AP 105-2 as depicted in FIG. 1) form a CG with AP 105-2 acting as the leader and AP 105-1 acting as the follower, AP 105-1 may transmit STA 110-3's RU-specific report to AP 105-2 (step 330). Utilizing the reports received from all follower APs, AP 105-2 may construct a consistent RF environment map that spans across BSS boundaries (step 335). The map may provide an overview of the spectrum utilization and interference patterns within the CG's coverage area. Following the receipt of these detailed reports, APs 105-1 and 105-2 may initiate the negotiation for RU allocation and the fine-tuning of network settings (step 340). AP 105-2 may conduct a thorough assessment and evaluate the potential impacts of the RU allocation or network adjustments on spatial reuse efficiency and network performance across the CG. If the assessment reveals that proposed RU allocation or network adjustments may potentially improve the overall network performance, AP 105-2 may approve the requests. Alternatively, if the proposed RU allocation or network adjustments are considered to potentially compromise the network efficiency, AP 105-2 may deny the request, and/or send back instructions to AP 105-1, directing it to further refine its RU allocation or network adjustments.

After the negotiation is complete, AP 105-1 communicates the results to STA 110-3 (step 345). The instruction may include any approved RU allocations, and/or specific instructions for adjusting network settings, such as MAPC mode selection, transmit power level adjustment, or medium access parameter (OBSS/PD threshold) modifications. Upon receiving the instructions from AP 105-1, STA 110-3 proceeds to perform data transmission using the allocated RUs (step 350). When the instructions include guidelines for adjusting network settings (e.g., switching to C-OFDMA mode, or increasing transmit power to 18 dBm), STA 110-3 implements required operations to update its settings in accordance with the provided guidelines (step 355).

Following these adjustments, STA 110-3 sends an acknowledgement to AP 105-1 (step 360), confirming that the allocated RUs are now being used for data transmission and/or its network settings have been updated in accordance with the provided guidelines.

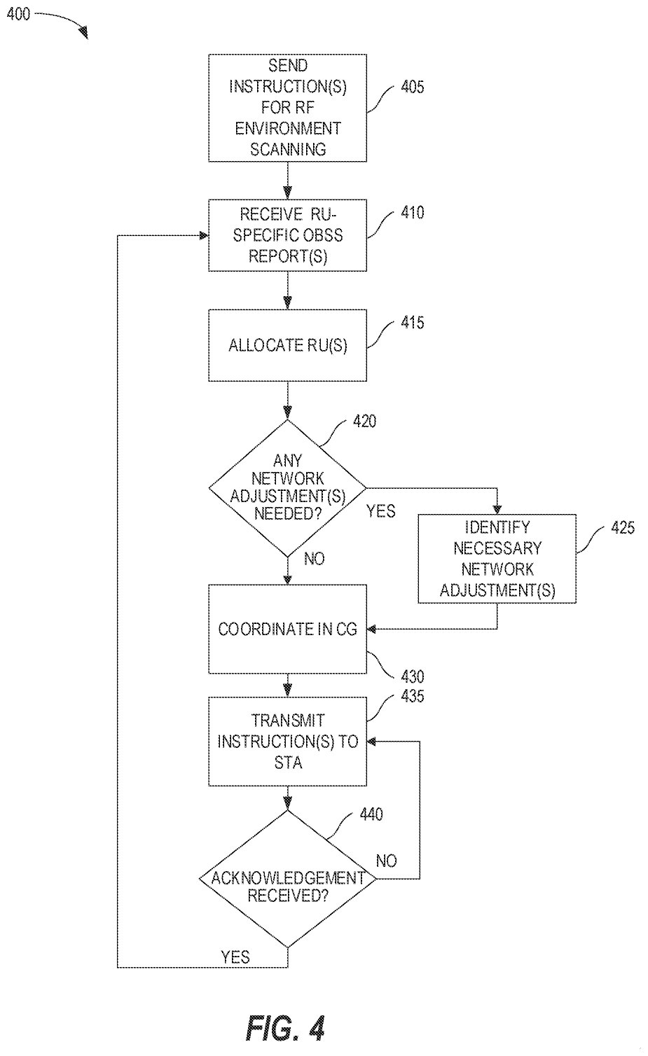

FIG. 4 depicts an example method 400 of an AP optimizing RU allocation for spatial reuse, utilizing detailed per-RU reporting from associated client devices, according to some embodiments of the present disclosure. In some embodiments, the method 400 may be performed by one or more APs, such as APs 105-2 and 105-2 as depicted in FIGS. 1 and 3. In some embodiments, the method 400 may be performed by one or more other network devices that possess the required capabilities for dynamic network management, such as wireless controllers (WLCs), routers, network switches, and the like.

The method 400 begins at block 405, where an AP (e.g., AP 105-1 of FIG. 1) sends instructions for RF environment monitoring and reporting to one of its associated STAs (e.g., STA 110-3 of FIG. 1). The instruction may guide the STA to scan its RF environment, including identifying the occupancy status of each RU within the operating channel (whether it is unoccupied or occupied by STAs within the same BSS or from neighboring BSSs), and measuring the signal strength or power level of transmissions on each RU. In some embodiments, the instruction may include the AP's general monitoring and reporting policy. In some embodiments, the general policy may specify the metrics, such as RSSI or SNR, used to measure and report signal strength (or power level), as well as the desired level of granularity (whether on a per-RU basis or for a defined number of RUs or sub-channels). In some embodiments, the policy may also define the frequency and type of reporting by the STAs, which include, but are not limited to, the period reporting (where STAs automatically send updates at regular intervals), the on-demand reporting (triggered by specific requests from APs), or the threshold-driven reporting (initiated when signal strength or other metrics cross predefined thresholds).

In some embodiments, the instructions from the AP may request for more targeted monitoring and reporting concerning specified OBSSs. For example, within the example wireless environment 100 as depicted in FIG. 1, AP 105-1 may identify BSS 2 as a potential source of interference due to its proximity to BSS 1. Additionally, given this proximity and the STA 110-3's location within the overlapping area between BSS 1 and BSS 2, STA 110-2 could potentially reuse RUs that are underutilized by BSS 2. In such configurations, AP 105-1 may include the identifiers, such as BSSIDs or BSS Colors associated with BSS 2, within the instructions sent to STA 110-3. Upon receiving these instructions, STA 110-3, instead of or in addition to conducting a broad and general scan of the operating channel, may utilize these identifiers to specifically identify RUs occupied by potential sources of interference, like devices from BSS 2. This approach may enable STAs to conduct their scan more efficiently to identify the RUs of interest, and assess their signal strength or power levels with greater accuracy.

At block 410, the AP (e.g., AP 105-1 of FIG. 1) receives RU-specific OBSS spatial reuse reports from one of its associate STAs (e.g., STA 110-3 of FIG. 1). The reports may include the occupancy status of RUs within the scanned channel, along with their respective performance metrics, such as power levels and/or signal strength (e.g., RSSI or SNR). As discussed above, the RU-specific data may be communicated using the newly defined OBSS Spatial Reuse Report element, which is incorporated within the Beacon Report Response frames.

At block 415, based on the OBSS reports, the AP allocates RUs for data transmission to the reporting STA. In some embodiments, such as when the reporting STA (e.g., STA 110-3 of FIG. 1) is located at the cell edge or within an overlapping area with another BSS (indicating a potential for spatial reuse), the AP may allocate unoccupied RUs and/or underutilized RUs from neighboring BSSs to the STA. In some embodiments, unoccupied RUs may be identified through their signal strength. For example, when the measured signal strength for an RU falls below a predefined noise floor threshold, it suggests that the RU has minimal or no current usage. In some embodiments, RUs occupied by devices from neighboring BSSs may be identified using the identifiers (e.g., BSSIDs or BSS Colors) provided in the STA's OBSS report. For RUs utilized by its own BSS, the AP may follow strict rules, such as not using these RUs unless they are empty (which may involve implementing a contention window (CW) mechanism to manage access among its associated STAs). For RUs utilized by neighboring BSSs, the AP may adopt more relaxed rules, which allow the STA to use RUs that are not fully utilized for data transmission, thereby optimizing spatial reuse gains. To determine whether the identified RUs are being utilized to their full capacity, in some embodiments, the AP may analyze the signal strength or power levels as reported by the STA. By comparing these metrics against established thresholds, like OBSS/PD thresholds, the AP may identify the current level of utilization and the interference potential for each RU.

At block 420, the AP evaluates whether adjustments to network settings are necessary to further enhance spatial reuse gains. The network setting adjustments may include changing MAPC mode (e.g., switching to C-OFDMA or C-FDMA based on RU-level reporting), adjusting transmit power to improve communication for STAs at the cell edge (e.g., increasing power levels), or modifying medium access parameters (e.g., CW sizes or the OBSS/PD thresholds) to manage access contention more effectively. In some embodiments, network setting adjustments may be needed when detecting changes in network congestion levels, such as the presence of new sources of interference that impact the STA's quality of service, or when feedback from the reporting STA shows increased traffic or interference levels within certain allocated RUs. If the AP determines that network setting adjustments are needed, the method 400 proceeds to block 425, where the AP analyzes the network conditions, and identifies the specific adjustment needed. If no adjustments are considered necessary, the method 400 proceeds directly to block 430.

At block 430, the AP coordinates the RU allocation and any network adjustments within the CG leader (e.g., AP 105-2 of FIG. 1). The coordination may occur when the AP is part of a CG and acts as a follower. The coordination ensures that the AP's decision (regarding RU allocation or network setting adjustments) is in accordance with the broader network optimization strategies agreed upon within the CG.

At block 435, the AP, upon receiving approval from the CG leader, proceeds to transmit the RU allocation and/or any network adjustment instructions to the reporting STA. The transmission includes specific guidance on which RUs have been allocated for the STA's use, as well as any required changes to network settings, such as adjusting power levels, switching MAPC modes, or modifying medium access parameters. These instructions may enable the STA to effectively utilize the allocated RUs, and operate within the optimized network parameters set by the AP.

At block 440, the AP checks for an acknowledgement from the STA. The acknowledgement may serve as confirmations from the STA that it has received the RU allocation and/or network adjustment instructions, and/or has implemented them accordingly. If the acknowledgement is received, indicating successful communication and implementation of the instructions by the STA, the method 400 returns to block 410, where the AP continues to monitor network conditions based on the received reports. Through ongoing monitoring, the AP may quickly respond to any changes in the network environment to maintain network performance and optimize spatial reuse gains. If the acknowledgement is not received, suggesting a potential issue in the communication or implementation process, the method 400 returns to block 435, where the AP resends the instructions to ensure that the STA receives the necessary guidance for RU allocation and network adjustments.

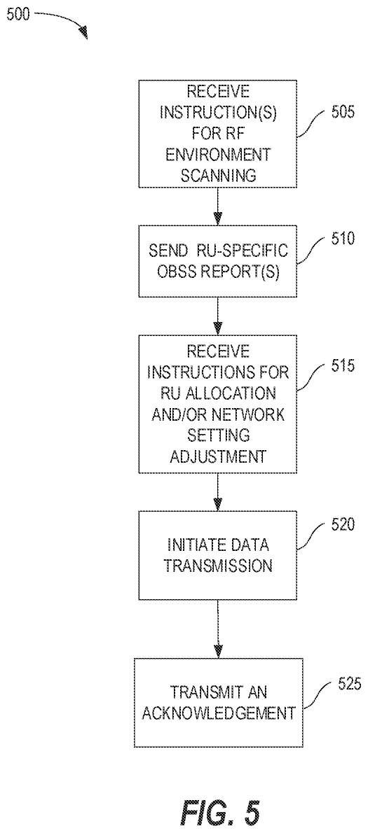

FIG. 5 depicts an example method 500 of a client device scanning its radio frequency environment and reporting per-RU performance metrics for optimized RU allocation, according to some embodiments of the present disclosure. In some embodiments, the method 500 may be performed by one or more STAs, such as STAs 110 as depicted in FIG. 1, and STA 110-3 as depicted in FIG. 3.

At block 505, a client device (or STA) (e.g., STA 110-3 of FIG. 1) receives instructions from its associated AP (e.g., AP 105-1 of FIG. 1) for scanning the operating channel. As discussed above, in some embodiments, the instruction may include the AP's general monitoring and reporting policy. For example, the instruction may specify the granularity of data collection (such as signal strength measurements for each RU or for a number of RUs), and the type and frequency of reporting (such as periodic reporting, on-demand reporting, or threshold-driven reporting). In some embodiments, the instruction may be more specific, directing the STA to monitor RUs utilized by particular BSSs that are identified as potential sources of interference.

At block 510, the client device aggregates the data into an RU-specific OBSS report, and sends it to the associated AP. The report may include RU occupancy and relevant performance metrics (e.g., signal strength, power levels). In some embodiments, a new OBSS Spatial Reuse Report element may be defined to transmit the RU-specific data from the STAs to APs. In some embodiments, the newly-defined element may be incorporated into existing Beacon Report Request/Response frames, which therefore enables efficient communications of RU-specific spatial reuse data within the standard operational flows.

At block 515, the client device receives instructions from its associated AP. The instructions may include RU allocation and/or any necessary network setting adjustments. In some embodiments, the RU allocation and necessary network setting adjustments may be determined by the AP based on the OBSS reports and/or its predefined QoS strategies. In some embodiments, such as when the AP is part of a CG, the RU allocation and necessary network setting adjustments may be coordinated by the AP with its CG leader to ensure alignment with the broader network optimization strategies.

At block 520, the client device initiates data transmission using the allocated RUs, and/or adjusts its network settings according to the AP's instructions. In some embodiments, the adjustments may include changes to MAPC mode, transmit power levels, or medium access parameters to enhance spatial reuse and network performance.

At block 525, after implementing the RU allocations and network adjustments, the client device sends an acknowledgement to the AP. The acknowledgement may confirm the receipt of the instructions, and indicate that the allocated RUs are now being used for data transmission, and that any adjustments to network settings have been successfully implemented by the client device.

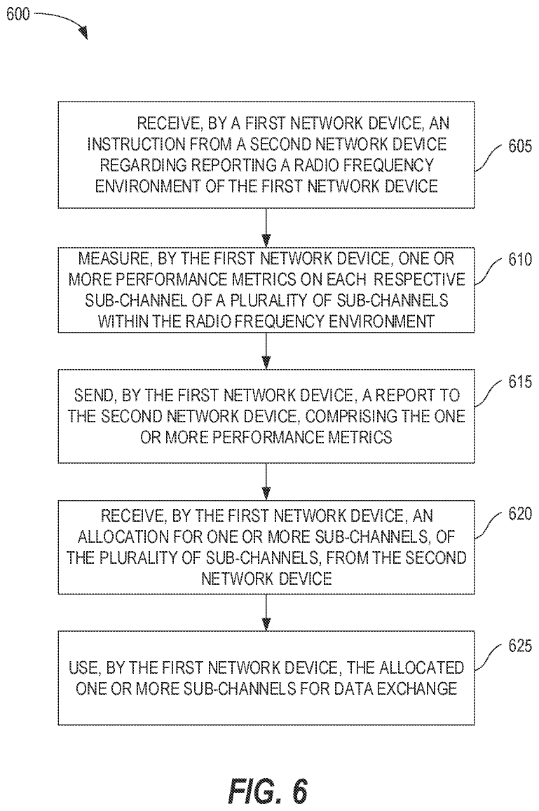

FIG. 6 is a flow diagram depicting an example method 600 for RU allocation guided by detailed per-sub-channel reporting and analysis, according to some embodiments of the present disclosure.

At block 605, a first network device (e.g., STA 110-3 of FIG. 1) receives an instruction from a second network device (e.g., AP 105-1 of FIG. 1) regarding reporting a radio frequency environment of the first network device (as depicted by step 305 of FIG. 3). In some embodiments, the instruction may comprise a reporting policy that specifies at least one of (i) a granularity of measuring the one or more performance metrics or (ii) a type of the report. In some embodiments, the type of the report may comprise at least one of a periodic report, an on-demand report, or a threshold-driven report. In some embodiments, the first and second network devices may be within a first network cell (e.g., BSS 1 of FIG. 1), and the second network device sends the report to a third network device (e.g., AP 105-2 of FIG. 1) within a second network cell (e.g., BSS 2 of FIG. 1). In some embodiments, the first and second network cells may form a coordination group (CG), and the third network device, based on the report, optimizes frequency reuse across the first and second network cells.

At block 610, the first network device measures one or more performance metrics on each respective sub-channel (e.g., 215-1 of FIG. 2) of a plurality of sub-channels within the radio frequency environment (as depicted by step 310 of FIG. 3). In some embodiments, the one or more performance metrics may comprise at least one of (i) a received signal strength indication (RSSI) value, or (ii) a signal-to-noise ratio (SNR) value. In some embodiments, the plurality of sub-channels may correspond to resource units (RUs) assigned for data transmission.

At block 615, the first network device sends a report to the second network device, comprising the one or more performance metrics (as depicted by step 315 of FIG. 3).

At block 620, the first network device receives an allocation for one or more sub-channels, of the plurality of sub-channels, from the second network device (as depicted by step 345 of FIG. 3).

At block 625, the first network device uses the allocated one or more sub-channels (as depicted by step 350 of FIG. 3) for data exchange. As used herein, the data exchange may include the first network device transmitting data, receiving data, or both transmitting and receiving data (concurrently or sequentially).

In some embodiments, the second network device (e.g., AP 105-1 of FIG. 1), based on the report received from the first network device, may generate a map of the radio frequency environment. In some embodiments, the second network device, based on the report received from the first network device, may perform at least one of operations including allocating the one or more sub-channels, of the plurality of sub-channels, to the first network device (as depicted by step 320 of FIG. 3), switching multi-AP coordination (MAPC) mode, adjusting one or more transmission power settings of the first network device, or modifying one or more medium access parameters of the first network device (as depicted by step 325 of FIG. 3).

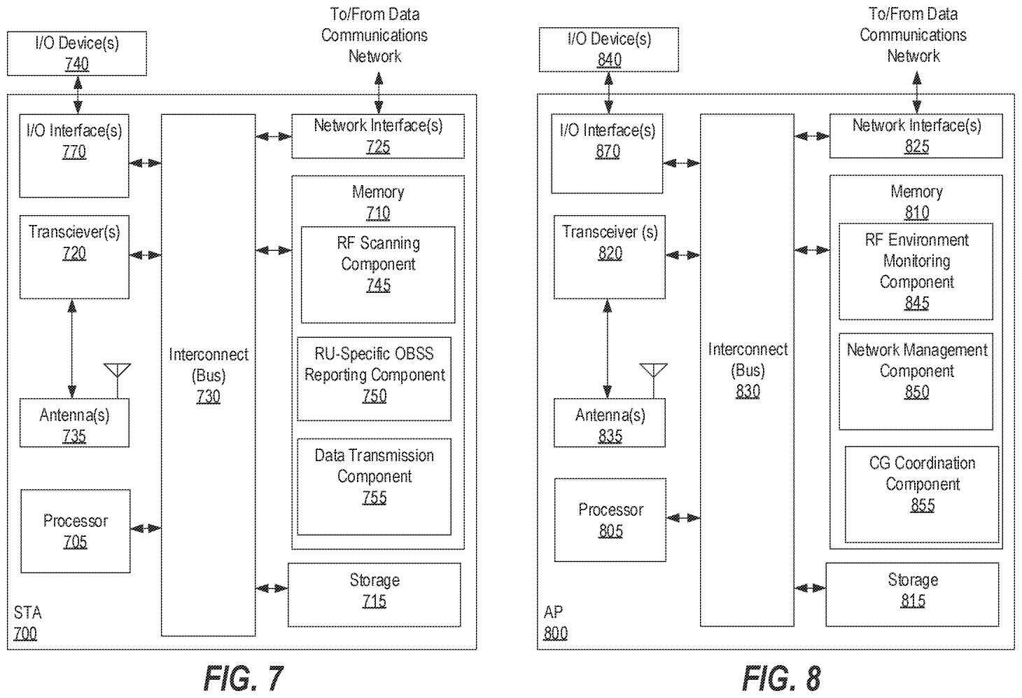

FIG. 7 depicts an example client device 700 supporting RU-specific reporting, according to some embodiments of the present disclosure. In some embodiments, the example client device 700 may correspond to the STAs 110 as depicted in FIG. 1, and the STA 110-3 as depicted in FIG. 3.

As illustrated, the client device 700 includes a processor 705, memory 710, storage 715, one or more transceivers 720, one or more I/O interfaces 770, and one or more network interfaces 725. In some embodiments, I/O devices 740 are connected via the I/O interface(s) 770. Further, via the network interface 725, the client device 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 770, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for efficient functioning of the system.

The memory 710 may include random access memory (RAM) and read-only memory (ROM). The memory 710 may store processor-executable software code containing instructions that, when executed by the processor 705, enable the device 700 to perform various functions described herein for wireless communication. In the illustrated example, the memory 710 includes three software components: the RF scanning component 745, the RU-specific OBSS reporting component 750, and the data transmission component 755. In some embodiments, the RF scanning component 745 may be configured to scan and monitor the operating channels following the AP's instructions. The scanning and monitoring process may include identifying the occupancy status of RUs (whether they are unoccupied, used by the client device's own BSS, or by neighboring BSSs), and gathering other relevant metrics like signal strength or power levels. After scanning the RF environment, in some embodiments, the RU-specific OBSS reporting component 750 may aggregate the collected data into a structured OBSS report, and send it to the client device 700's associated AP. The report may detail RU occupancy, signal strength, and other performance metrics relevant for the AP's decision-making process regarding RU allocation and network setting adjustments. The reporting mechanism may be periodic (where reports are sent at regular intervals), on-demand (initiated by an AP's request), or threshold-driven (triggered when certain criteria are met). In some embodiments, the data transmission component 755 manages data transmission over the RUs allocated by the AP. When the received instructions from the AP include specific network adjustments, the data transmission component 755 may adapt its operation accordingly, such as switching to designated MAPC modes, modifying transmit power levels, or changing medium access parameters (e.g., OBSS/PD threshold or CW), to optimize spatial reuse gains.

Although depicted as a discrete component for conceptual clarity, in some embodiments, the operations of the depicted components (and others not illustrated) may be combined or distributed across any number of components. Further, although depicted as software residing in memory 710, in some embodiments, the operations of the depicted components (and others not illustrated) may be implemented using hardware, software, or a combination of hardware and software.

FIG. 8 depicts an example AP 800 supporting dynamic RU allocation based on RU-specific reporting, according to some embodiments of the present disclosure. In some embodiments, the example AP 800 may correspond to the APs 105 as depicted in FIG. 1, and the APs 105-1 and AP 105-2 as depicted in FIG. 3.

As illustrated, the example AP 800 includes a processor 805, memory 810, storage 815, one or more transceivers 820, one or more I/O interfaces 870, and one or more network interfaces 825. In some embodiments, I/O devices 840 are connected via the I/O interface(s) 870. Further, via the network interface 825, the AP 800 can be communicatively coupled with one or more other devices and components (e.g., via a network, which may include the Internet, local network(s), and the like). Each of the components is communicatively coupled by one or more buses 830. In some embodiments, one or more antennas 935 may be coupled to the transceivers 820 for transmitting and receiving wireless signals.

The processor 805 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 805 processes information received through the transceiver 820, I/O interfaces 870, and the network interfaces 825. The processor 805 retrieves and executes programming instructions stored in memory 810, as well as stores and retrieves application data residing in storage 815.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for efficient functioning of the system.

The memory 810 may include random access memory (RAM) and read-only memory (ROM). The memory 810 may store processor-executable software code containing instructions that, when executed by the processor 805, enable the AP 800 to perform various functions described herein for wireless communication. In the illustrated example, the memory 810 includes three software components: the RF environment monitoring component 845, the network management component 850, and the CG coordination component 855. In some embodiments, the RF environment monitoring component 845 may manage the AP 800's associated STAs for RF environment scanning. In some embodiments, the RF environment monitoring component 845 may broadcast a general monitoring and reporting policy to all its associated STAs, which sets the framework for how STAs should scan the operating channels (e.g., per RU or sub-channel), and report the data collected. In some embodiments, the RF environment monitoring component 845 may send instructions to specific STAs, directing these devices to monitor interference caused by certain BSSs (e.g., BSSs that are close to the example AP and therefore identified as potential sources of interference). In some embodiments, the network management component 650 may analyze the RF environment data (included within RU-specific OBSS reports received from associated STAs) to identify active RUs within the scanned channel and their relevant metrics (e.g., transmit power levels, RSSI, SNR). Based on the analyzed data, the network management component 850 may decide on RU allocation and/or network setting adjustments, and transmit the decisions to the relevant STAs. In some embodiments, the CG coordination component 855 may engage in coordination with the CG leader, to ensure the AP 800's RU allocation and/or network adjustments are consistent with the collective goals and strategies of the CG. In some embodiments, the CG coordination component 855 may share RU-specific OBSS reports (received by the AP 800 from its associated STAs) with the CG leader, and receive guidance or approval for proposed RU allocation and network adjustments.

Although depicted as a discrete component for conceptual clarity, in some embodiments, the operations of the depicted components (and others not illustrated) may be combined or distributed across any number of components. Further, although depicted as software residing in memory 810, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product.

Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, by a first network device, an instruction from a second network device regarding reporting a radio frequency environment of the first network device;
measuring, by the first network device, one or more performance metrics on each respective sub-channel of a plurality of sub-channels within the radio frequency environment;
sending, by the first network device, a report to the second network device, comprising the one or more performance metrics;
receiving, by the first network device, an allocation for one or more sub-channels, of the plurality of sub-channels, from the second network device; and
using, by the first network device, the allocated one or more sub-channels for data exchange.

2. The method of claim 1, wherein the one or more performance metrics comprise at least one of (i) a received signal strength indication (RSSI) value, or (ii) a signal-to-noise ratio (SNR) value.

3. The method of claim 1, wherein the instruction comprises a reporting policy that specifies at least one of (i) a granularity of measuring the one or more performance metrics or (ii) a type of the report.

4. The method of claim 3, wherein the type of the report comprises at least one of a periodic report, an on-demand report, or a threshold-driven report.

5. The method of claim 1, wherein the second network device, based on the report received from the first network device, generates a map of the radio frequency environment.

6. The method of claim 1, wherein the second network device, based on the report received from the first network device, performs at least one of:
allocating the one or more sub-channels, of the plurality of sub-channels, to the first network device,
switching multi-AP coordination (MAPC) mode,
adjusting one or more transmission power settings of the first network device, or
modifying one or more medium access parameters of the first network device.

7. The method of claim 1, wherein the first and second network devices are within a first network cell, and the second network device sends the report to a third network device within a second network cell.

8. The method of claim 7, wherein the first and second network cells form a coordination group (CG), and the third network device, based on the report, optimizes frequency reuse across the first and second network cells.

9. The method of claim 1, wherein the plurality of sub-channels correspond to resource units (RUs) assigned for data transmission.

10. A system comprising:
one or more computer processors; and
one or more memories collectively containing one or more programs, which, when executed by the one or more computer processors, perform operations, the operations comprising:
receiving, by a first network device, an instruction from a second network device regarding reporting a radio frequency environment of the first network device;
measuring, by the first network device, one or more performance metrics on each respective sub-channel of a plurality of sub-channels within the radio frequency environment;
sending, by the first network device, a report to the second network device, comprising the one or more performance metrics;
receiving, by the first network device, an allocation for one or more sub-channels, of the plurality of sub-channels, from the second network device; and
using, by the first network device, the allocated one or more sub-channels for data exchange.

11. The system of claim 10, wherein the one or more performance metrics comprise at least one of (i) a received signal strength indication (RSSI) value, or (ii) a signal-to-noise ratio (SNR) value.

12. The system of claim 10, wherein the instruction comprises a reporting policy that specifies at least one of (i) a granularity of measuring the one or more performance metrics or (ii) a type of the report.

13. The system of claim 12, wherein the type of the report comprises at least one of a periodic report, an on-demand report, or a threshold-driven report.

14. The system of claim 10, wherein the second network device, based on the report received from the first network device, generates a map of the radio frequency environment.

15. The system of claim 10, wherein the second network device, based on the report received from the first network device, performs at least one of:
allocating the one or more sub-channels, of the plurality of sub-channels, to the first network device,
switching multi-AP coordination (MAPC) mode,
adjusting one or more transmission power settings of the first network device, or
modifying one or more medium access parameters of the first network device.

16. The system of claim 10, wherein the first and second network devices are within a first network cell, and the second network device sends the report to a third network device within a second network cell.

17. The system of claim 16, wherein the first and second network cells form a coordination group (CG), and the third network device, based on the report, optimizes frequency reuse across the first and second network cells.

18. The system of claim 10, wherein the plurality of sub-channels correspond to resource units (RUs) assigned for data transmission.

19. One or more non-transitory computer-readable media containing, in any combination, computer program code that, when executed by a computer system, performs operations comprising:
receiving, by a first network device, an instruction from a second network device regarding reporting a radio frequency environment of the first network device;
measuring, by the first network device, one or more performance metrics on each respective sub-channel of a plurality of sub-channels within the radio frequency environment;
sending, by the first network device, a report to the second network device, comprising the one or more performance metrics;
receiving, by the first network device, an allocation for one or more sub-channels, of the plurality of sub-channels, from the second network device; and
using, by the first network device, the allocated one or more sub-channels for data exchange.

20. The one or more non-transitory computer-readable media of claim 19, wherein the second network device, based on the report received from the first network device, performs at least one of:
allocating the one or more sub-channels, of the plurality of sub-channels, to the first network device,
switching multi-AP coordination (MAPC) mode,
adjusting one or more transmission power settings of the first network device, or
modifying one or more medium access parameters of the first network device.
